(19) United States
(12) Patent Application Publication
(10) Pub. No.: US 2016/0325469 A1
(43) Pub. Date: Nov. 10, 2016

(54) METHODS FOR IMPROVED SPRAY COOLING OF PLASTICS

(71) Applicants: Matthew Hershkowitz, West Caldwell, NJ (US); Mikael Orsén, Chatham, NJ (US)

(72) Inventors: Matthew Hershkowitz, West Caldwell, NJ (US); Mikael Orsén, Chatham, NJ (US)

(21) Appl. No.: 14/703,235

(22) Filed: May 4, 2015

(51) Int. Cl. B29C 35/16

(52) U.S. Cl. CPC B29C 35/16; B29C 2035/1658; B29K 2023/10

(57) ABSTRACT

A method for cooling areas of a mold used for producing plastic parts wherein the areas to be cooled are at a higher temperature than other areas of the mold comprising directing carbon dioxide at the surface of the mold to be cooled. This cooling will shorten the cycle time for producing the plastic parts thereby increasing throughput and cost savings.

### BACKGROUND OF THE INVENTION

The invention relates to a method for producing plastic parts according to the injection molding method, wherein a molding tool is closed to form a cavity in the interior of the molding tool, a plastic melt is injected into the cavity and allowed to cool and solidify, the molding tool opens and the part is removed. The time required to complete a full cycle of the above described process is the molding cycle time.

During the injection molding process, it is often found that due to ineffective cooling by water or other cooling methods and a lack of heat dissipation by the molding tool that areas of the mold are much hotter (“hot spots”) than the remainder of the mold. Consequently, the cooling time, and subsequently the molding cycle time, is extended to allow the plastic to cool and solidify more before being removed. The cooling time is the time between when the plastic is completely injected into the mold and when the mold is opened.

It has been discovered that by using carbon dioxide cooling that these hot spots can be significantly reduced, thereby enabling the cooling time to be reduced and resulting in an overall reduction in molding cycle time, The reduction in molding cycle time will directly correlate to an increase in throughput or a reduction in cost.

### SUMMARY OF THE INVENTION

In a first embodiment of the invention, there is disclosed a method for cooling a mold used in the production of plastic parts comprising directing carbon dioxide at the surface of the mold cavity.

In a different embodiment of the invention, there is disclosed a method for cooling areas of a mold used for producing plastic parts wherein the areas to be cooled are at a higher temperature than other areas of the mold comprising directing carbon dioxide at the surface of the mold to be cooled,

The carbon dioxide is directed at the surface of the mold cavity. The carbon dioxide is directed at areas of the mold cavity that are higher in temperature than other areas of the mold. The higher temperature areas are located using a device selected from the group consisting of a temperature probe, an infrared measurement device or similar device.

The carbon dioxide is directed at the mold through a nozzle. The nozzle creates a mixture of carbon dioxide gas and snow.

The production of plastic parts is by injection molding. The plastic parts are selected from the group consisting of poly propylene with or without glass reinforcement, polyamides with or without glass reinforcement, acryl-butadiene-styrene, poly carbonates and mixtures thereof.

The carbon dioxide is directed at the mold cavity surface after the plastic part is formed. The carbon dioxide is delivered at a pressure of 800 to 1000 pounds per square inch. The carbon dioxide is at a temperature of −109° F. (−78.3° C.). The cooling time ranges from 1 to 600 seconds, more preferably, 10 to 300 seconds in length.

When a plastic part is produced in a mold, given the intricacy of the part and the mold, the areas of the mold will cool down at different rates. As noted above, this can cause problems with the finished plastic part It is therefore desirable to provide cooling to those areas of the mold that are at higher temperatures rather than allowing these hotter areas to cool naturally which lengthens the overall time molding cycle time.

The present invention has the ability to target specific areas of a mold that are at a higher temperature and by directing the stream of carbon dioxide at this hotter area cool it down thereby equalizing the temperature of the overall mold and shortening the cycle time for the production of plastic parts.

The mold is typically those molds used for the injection molding of plastic parts. These molds generally comprise two large blocks of steel with half of the cavity removed from each side. The mold also has water cooling channels, pins to eject the part, lifters, kickers and a runner system to inject plastic.

### DETAILED DESCRIPTION OF THE INVENTION

In a typical injection molding operation according to the invention a series of steps is followed in producing the plastic part.

First the mold is closed and hot enough to allow for the plastic to flow throughout the cavity; melted plastic is injected at pressure into the cavity of the mold. The mold will then sit for a time period during which the plastic cools and solidifies. During this cooling period, the heat from the plastic is absorbed into the steel mold. Plastics have poor heat transmission capability, and therefore hotter areas of the mold reduce the temperature differential and make the cooling rate slower.

Once cooled, the mold opens and a robot or person removes the part from the mold. The plastic part may also just come off easily from the mold and slide into a collection bin when the mold is opened.

The carbon dioxide will be directed to areas of the mold that do not readily disperse the heat absorbed from the plastic. This application of the carbon dioxide will reduce the cooling time of the plastic. As a result, the total molding cycle time can be reduced as cooling time can represent 20 to 90% of the cycle time depending upon the plastic part and the cycle time itself. The lower percentage cycle time are normally when the cycle time is below 30 seconds and the higher percentages are more when the cycle time is over 300 seconds in length.

Liquid carbon dioxide is supplied at 800 to 1000 pounds per square inch (psi) to a nozzle. Typical nozzles that may be employed are LINSPRAY® nozzles available from Linde AG and described in EP Patent 0 546 359 B1. The carbon dioxide supply may be from either liquid carbon dioxide cylinders with a siphon (dip) tube or from a bulk carbon dioxide tank depending upon the amount of carbon dioxide necessary for cooling purposes. If the liquid carbon dioxide is from a bulk tank, a pressure boosting unit must be employed to increase the pressure to 900 to 1000 psi.

The liquid carbon dioxide flows through stainless steel hoses to the LINSPRAY® solenoid valves which are controlled by a 24V DC signal. These valves may be triggered manually or automatically through the use of a programmable logic control (PLC) device. When the valves are opened by the signal, liquid carbon dioxide flows through the LINSPRAY® nozzles and forms a carbon dioxide snow and gas at −109° F. (−78.3° C.) in a concentrated jet. This jet will target specific areas of the mold to effectively cool down that area and equalize the temperature throughout the mold. By equalizing the temperature throughout the mold, the cooling time can be reduced thereby resulting in an overall reduction in molding cycle time.

The nozzles may have fine filters placed over their ends to ensure long operation as well as the appropriate pollution control. The nozzles per the LINSPRAY® process have a pre-chamber at the mouth end in which the liquid carbon dioxide is expanded via a calibrated slit nozzle. This design is useful in the methods of the instant invention in that the pre-chamber efficiently allows the carbon dioxide to completely expand thereby maximizing its cooling efficiency when directed to the hot spots to be treated.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for cooling a mold used in the production of plastic parts comprising directing carbon dioxide at the surface of the mold.

2. The method as claimed in claim 1 wherein the carbon dioxide is directed at areas of the mold that are higher in temperature than other areas of the mold.

3. The method as claimed in claim 1 wherein the production of plastic parts is by injection molding.

4. The method as claimed in claim 1 wherein the carbon dioxide is directed at the surface of the mold cavity.

5. The method as claimed in claim 1 wherein the higher temperature areas are located using a device selected from the group consisting of a temperature probe and an infrared measurement device.

6. The method as claimed in claim 1 wherein the plastic parts are selected from the group consisting of poly propylene with or without glass reinforcement, polyamides with or without glass reinforcement, acryl-butadiene-styrene, poly carbonates and mixtures thereof.

7. The method as claimed in claim 1 wherein the cooling ranges from 1 to 600 seconds in length.

8. The method as claimed in claim 7 wherein the cooling ranges from 10 to 300 seconds in length.

9. The method as claimed in claim 1 wherein the carbon dioxide is directed at the mold through a nozzle.

10. The method as claimed in claim 1 wherein the nozzle creates a mixture of carbon dioxide gas and snow.

11. The method as claimed in claim 1 wherein the carbon dioxide is directed at the mold after the plastic part is formed.

12. The method as claimed in claim 1 wherein the carbon dioxide is delivered at a pressure of 800 to 1000 pounds per square inch.

13. The method as claimed in claim 1 wherein the carbon dioxide is at a temperature of −78.3° C.

14. A method for cooling areas of a mold used for producing plastic parts wherein the areas to be cooled are at a higher temperature than other areas of the mold comprising directing carbon dioxide at the surface of the mold to be cooled.

15. The method as claimed in claim 14 wherein the production of plastic parts is by injection molding.

16. The method as claimed in claim 14 wherein the carbon dioxide is directed at the external surface of the mold.

17. The method as claimed in claim 14 wherein the higher temperature areas are located using a device selected from the group consisting of a temperature probe and an infrared measurement device.

18. The method as claimed in claim 14 wherein the plastic parts are selected from the group consisting of poly propylene with or without glass reinforcement, polyamides with or without glass reinforcement, acryl-butadiene-styrene, poly carbonates and mixtures thereof.

19. The method as claimed in claim 14 wherein the cooling ranges from 1 to 600, more preferably 10 to 300, seconds in length.

20. The method as claimed in claim 19 wherein the cooling ranges from 10 to 300 seconds in length.

21. The method as claimed in claim 14 wherein the carbon dioxide is directed at the mold through a nozzle.

22. The method as claimed in claim 14 wherein the nozzle creates a mixture of carbon dioxide gas and snow.

23. The method as claimed in claim 14 wherein the carbon dioxide is directed at the mold after the plastic part is formed.

24. The method as claimed in claim 14 wherein the carbon dioxide is delivered at a pressure of 800 to 1000 pounds per square inch.

25. The method as claimed in claim 14 wherein the carbon dioxide is at a temperature of −78.3° C.
